(19) United States
(12) Patent Application Publication
(10) Pub. No.: US 2002/0178260 A1
(43) Pub. Date: Nov. 28, 2002

(54) Distributed computer resource bartering system

(76) Inventor: Hsin-Wang Wayne Chang, San Jose, CA (US)

Correspondence Address: Mr. C. P. Chang, Pacific Law Group LLP, Two North Second Street , Suite 290, San Jose, CA, 95113, US

(21) Appl. No.: 09/864,691

(22) Filed: May 23, 2001

(51) Int. Cl. G06F 15/173; G06F 15/167; G06F 9/00

(52) U.S. Cl. 709/225; 709/214; 709/105

(57) ABSTRACT

A Distributed Computer Resource Bartering System, or DCRBS, software is described whereby a fraction of the computing resources of the individual Peers is bartered amongst them with a single Coordinator software module and a multitude of Peer software modules. The Coordinator and Peer software modules would simultaneously communicate and functionally operate with one another through the software and hardware infrastructure of a computer networking environment such as the Internet. The bartering items of the DCRBS software are further individually valuated and classified into a number of major Bartering Categories, or BTRCT, to effect a natural and commerce driven exchange mechanism. The specific BTRCT includes, but without limitation to, computing power, computing memory, computing storage, computer peripherals, computer files, Internet Access and money.

### FIELD OF THE INVENTION

The present invention generally relates to a distributed computing system. More specifically, the present invention concerns the software for exchange, or bartering involving computing resources and their attached peripherals within a network of distributed and independently owned computer systems in an Internet environment. Some related applications are distributed computing for space sciences or life sciences, Peer-to-Peer E-commerce, Peer-to-Peer file swapping, Web site security testing and Web performance testing.

### BACKGROUND OF THE INVENTION

Historically, the evolution of computer in the commercial world went from a limited number of mainframes through many more mini-computers to, currently, a large number of generally independently owned and operated micro-computers and workstations. Meanwhile, the evolution of computer networking and related applications has, in recent years, transformed itself into an Internet revolution with, potentially, all the computers in the world connected and concurrently communicating with one another.

At this point, the concept of distributed computing whereby a huge number of computers, networked through the Internet, would compute in a coordinated way and thus act as if they were a single giant, super computer capable of solving heretofore unimaginable problems finally becomes possible. Distributed computing allows organizations to solve big or complex computational problems that they formerly used to refrain from tackling due to either the associated high cost of computing equipment or the excessive processing time. Technically, distributed computing works by taking a large task and dividing it into many smaller tasks and then distributing them among a corresponding number of computers running simultaneously and coordinating with one another via a computer network such as the Internet. After the individual tasks are completed by their respectively assigned computers, the resulting data from these tasks are transmitted back to a central server that then assembles the individual data into the desired answer.

In fact, in recent years, distributed computing has been steadily growing and is soon to be scaled into a global level with the maturation of the Internet infrastructure. For example, one already successful and popular project of distributed computing is the seminal Internet distributed computing project, or SETI@home, launched at the University of California at Berkeley in the year 1999. SETI™home performs computer search through multiple terabytes of data collected daily by the world's largest radio telescope, by using the collective computing power of a community of volunteers. The software runs during idle time of the volunteer's computer and searches for radio signal fluctuations that may indicate a sign of intelligent life. To date, over two million volunteers have participated in the SET™home project.

An explosively growing commercial activity enabled by the aforementioned revolution of computers and Internet is Peer-to-Peer (P2P) E-commerce whereby ready information access to commodities and highly dynamic commercial transactions of a variety take place through the Internet on a world wide basis. A popular, yet controversial example is Napster, a peer-to-peer music file sharing software. According to the market research of Media Metrix, at the end of August 2000, Napster had over 8 millions unique registered users and over 38 million software downloads.

Another emerging commercial application enabled by the revolution of computers and Internet is Web Site Security Testing. The security of any Web Site is of fundamental importance to its existence. As the number of Internet users continues to grow, so will the number of computer hackers and related computer viruses which, when allowed to filter through the Web Site, can and will disable or even permanently damage the computers handling the Web Site. To perform a quality Web Site Security Testing in a timely manner, one must utilize a large number of distributed computing resources coordinated over the Internet.

A third emerging commercial application enabled by the revolution of computers and Internet is Web Performance Stress Testing. Because most successful E-commerce applications depend on fast performance, 100% availability and robust scalability, Web Performance Stress Testing will become an integral part of the growth of E-commerce. To be representative of the reality, a quality Web Performance Stress Testing must again utilize a large number of distributed computing resources coordinated over the Internet.

A fourth potential commercial application enabled by the revolution of computers and Internet is PEER-TO-PEER Streamline Media Broadcasting whereby, instead of swapping files, the PEER-TO-PEER system is used to broadcast and to view streamlined rich media such as audio and video programs. With this application, every PC itself can be a media broadcasting station.

A fifth potential commercial application enabled by the revolution of computers and Internet is a Web Indexing Spider, also known as a “web-spider”, that uses peers from all over the world to do the web page indexing work and to construct the web database for a search engine.

A sixth potential commercial application enabled by the revolution of computers and Internet is a Peer Software Router. The Peer Software Router is a PEER-TO-PEER routing framework that is a super efficient distributing technology of digital content among a peer-to-peer network. In essence, this framework equips every node of the Internet with the functionality of both a server and a client.

A seventh potential commercial application enabled by the revolution of computers and Internet is a PEER-TO-PEER Game Coordinator for playing multi-player games networked most commonly via the Internet. Classically, the game providers or third-party companies always have to set up many of so-called “game-servers” to coordinate players scattered all around the world into groups for playing networked games. The PEER-TO-PEER Game Coordinator can achieve the same goal in a PEER-TO-PEER, or server-less way.

Yet another potential commercial application enabled by the revolution of computers and Internet, with the concurrent advancement of the wireless technology, is a Wireless PEER-TO-PEER Digital Content Swapping Platform based upon PDA, Cellular Phones, etc.

However, regardless of the high value and tremendous potential for growth of the above described examples of sharing of distributed and coordinated computing resources, to date, a commerce driven, comprehensive and flexible mechanism with associated operating software does not exist to naturally foster such resource sharing from the user community at large.

### SUMMARY OF THE INVENTION

The present invention aims to devise a commerce driven, comprehensive and flexible mechanism with associated operating software to foster the natural sharing of distributed and coordinated computing resources from the Internet user community. The subject mechanism and its associated operating software is named Distributed Computer Resource Bartering System, or DCRBS. More specifically, an objective of this invention is to devise a commerce driven mechanism and associated operating software through which computing resources can be naturally exchanged, or bartered, among the corresponding Internet user community thus accelerating the commercial growth of the related activities such as massively distributed computing, Peer-to-Peer Electronic Commerce, Peer-to-Peer file swapping, Web site security testing and Web performance testing.

Another objective of this invention is to make the subject bartering mechanism and associated operating software highly comprehensive so that a wide variety of computing and related resources can be exchanged among the corresponding Internet user community.

A third objective of this invention is to make the subject bartering mechanism and associated operating software highly flexible so that numerous combinations of bartering partners and modes of bartering processes can take place simultaneously among the corresponding Internet user community; and

A fourth objective of this invention is to make the subject bartering mechanism and associated operating software naturally scalable so that, as the size of the corresponding Internet user community grows, no major change of the architecture of the associated operating software needs to take place to maintain its functionality and performance.

Other objectives, together with the foregoing are also attained in the exercise of the current invention in the following description and resulting in the embodiment illustrated in the accompanying drawings.

### BRIEF DESCRIPTION OF DRAWINGS

These and other specifications, aspects, features, and advantages of the present invention will become better understood with regard to the following description, appended claims, and accompanying drawings where:

FIG. 1 is an illustration of the hardware environment of an Internet user community wherein certain fraction of computing resources of the individual users is shared through the hardware connection of the Internet infrastructure.

FIG. 2 illustrates the software environment of the Distributed Computer Resource Bartering System wherein certain fraction of computing resources of the individual users is bartered amongst them with a single Coordinator module and a multitude of Peer software modules that communicate with one another through the software infrastructure of the Internet.

FIG. 3 details the major categories of bartering of the Distributed Computer Resource Bartering System.

FIG. 4 illustrates a first example of bartering within the Distributed Computer Resource Bartering System wherein the subject bartering partners are the Coordinator module and Peer module-I.

FIG. 5 illustrates a second example of bartering within the Distributed Computer Resource Bartering System wherein the subject bartering partners are the Coordinator module and Peer module-II.

FIG. 6 illustrates a third example of bartering within the Distributed Computer Resource Bartering System wherein the subject bartering partners are the Coordinator module and Peer module-N.

FIG. 7 illustrates a fourth example of bartering within the Distributed Computer Resource Bartering System wherein the bartering activity between Peer module-II and Peer module-III is coordinated by the Coordinator module.

FIG. 8 illustrates a generalized view of bartering within the Distributed Computer Resource Bartering System wherein a multitude of bartering activities amongst the Coordinator module and many Peer modules take place simultaneously.

FIG. 9 details the process flow of the first example of bartering within the Distributed Computer Resource Bartering System from FIG. 4.

FIG. 9A, FIG. 9B, FIG. 9C and FIG. 9D further details the individual blocks of the process flow of FIG. 9.

### DETAILED DESCRIPTION OF PREFERRED EMBODIMENTS

Referring now to the drawings, in which like numerals refer to like objects throughout the drawings.

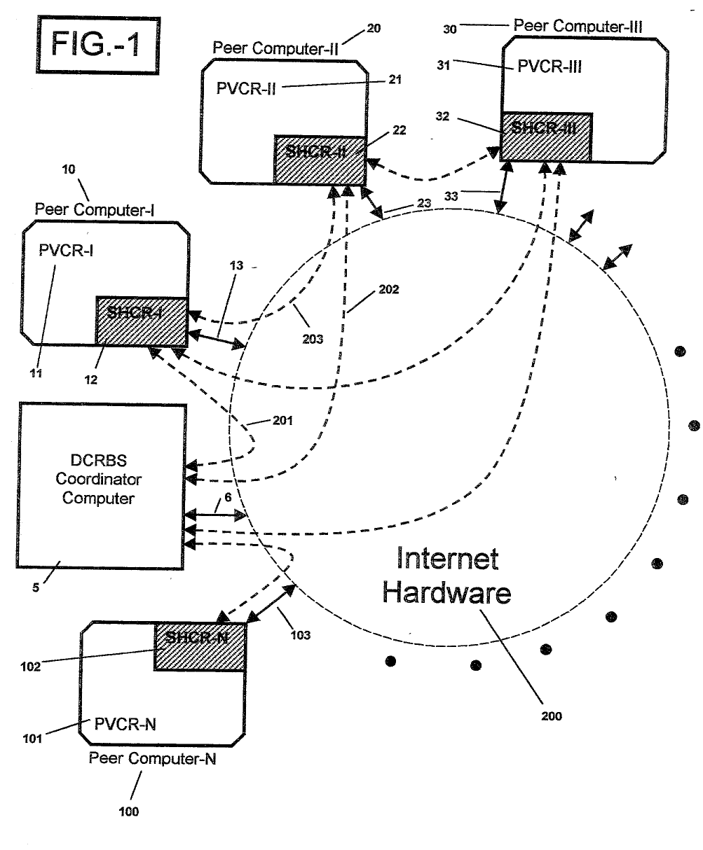

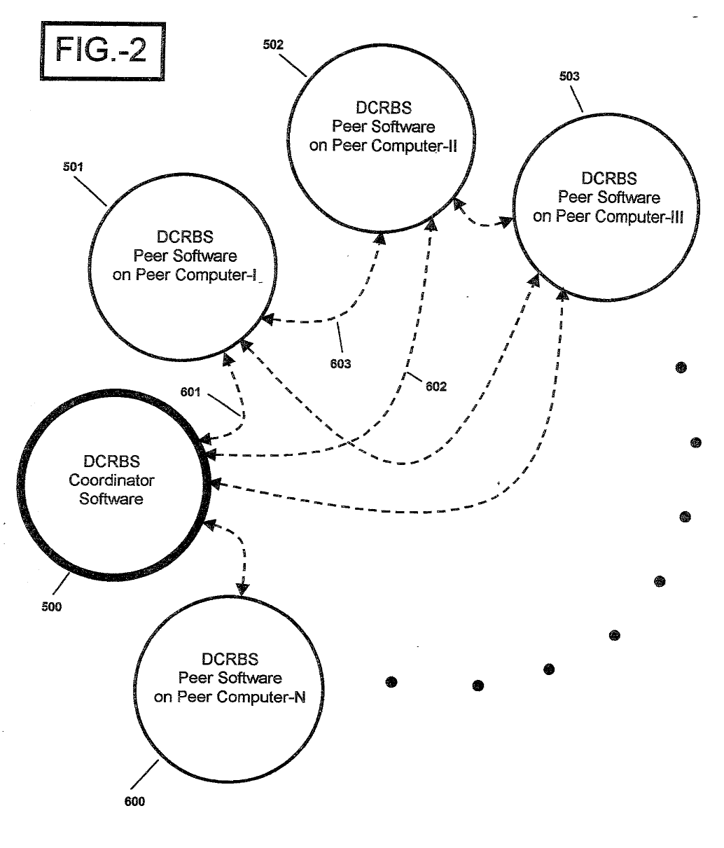

FIG. 1 illustrates the hardware environment of an Internet user community. A number, N, of Peer Computer-I 10, Peer Computer-II 20, Peer Computer-III 30, . . . and Peer Computer-N 100, together with a DCRBS Coordinator Computer 5 are communicatively connected through a Internet Hardware Infrastructure 200. Each of these computers can be of different types and sizes in terms of its computing power and its attached set of peripherals. For example, the Peer Computer-I 10 could be an IBM-PC with only a single peripheral of hard disk drive attached. To further illustrate, the DCRBS Coordinator Computer 5 could be a high performance Cray super computer with a large bank of disk drive array plus a large number of high speed laser printers attached, etc. In general, although all of the illustrated computers are independently owned and operated, a number of them could belong to a single business interest or enterprise. Of course, many of them could respectively belong to an end user as well. The Internet Hardware Infrastructure 200 is comprised of a large number of independently owned and operated, networking and communication devices and lines for world wide data transmission such as voice modems, DSL modems, switches, hubs, routers, gateways, telephone lines, T1 lines, T3 lines and fiber optical cables, etc. In fact, some of these communication devices and lines can even be of the wireless type within the context of the present invention. Nevertheless, the immediate hardware for the attachment of a computer to the Internet Hardware Infrastructure 200 is usually a modem, indicated as a hardware Internet access means of DCRBS Coordinator Computer 6 for the DCRBS Coordinator Computer 5, a hardware Internet access means of Peer Computer-I 13 for Peer Computer-I 10, a hardware Internet access means of Peer Computer-II 23 for Peer Computer-II 20, a hardware Internet access means of Peer Computer-III 33 for Peer Computer-III 30 and a hardware Internet access means of Peer Computer-N 103 for Peer Computer-N 100. The associated hardware routing path for data transmission amongst the computers are illustrated by a set of dashed lines each with arrowheads at both ends. These are the hardware routing path between DCRBS Coordinator Computer and Peer Computer-I 201,the hardware routing path between DCRBS Coordinator Computer and Peer Computer-II 202, and the hardware routing path between Peer Computer-I and Peer Computer-II 203, etc. The concept of DCRBS stipulates that a certain fraction of computing resources of the individual Peer computers will be shared and used by the DCRBS Coordinator Computer 5 through the corresponding hardware routing paths of the Internet Hardware Infrastructure 200. On the other hand, the other fraction of computing resources of the individual Peer computers will still be reserved for their respective private usage. Thus, for the Peer Computer-I 10, there is a Shared computer Resource of Peer Computer-I 12 and a Private computer Resource of Peer Computer-I 11. For the Peer Computer-II 20, there is a Shared computer Resource of Peer Computer-II 22 and a Private computer Resource of Peer Computer-II 21. For the Peer Computer-III 30, there is a Shared computer Resource of Peer Computer-II 32 and a Private computer Resource of Peer Computer-III 31. For the Peer Computer-N 100, there is a Shared computer Resource of Peer Computer-N 102 and a Private computer Resource of Peer Computer-N 101.

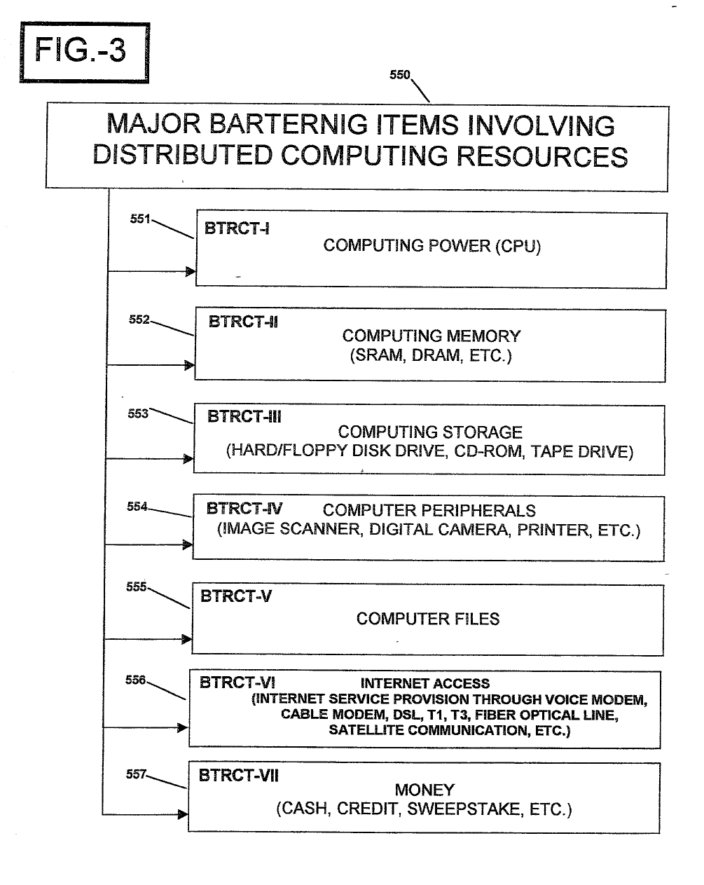

Mirroring the hardware environment, as shown in FIG. 1, of an Internet user community with the concept of DCRBS, the software environment of the Distributed Computer Resource Bartering System is illustrated in FIG. 2 wherein a DCRBS software module of the present invention is shown to be preinstalled and reside at each such computer within this system. That is, a DCRBS Coordinator Software 500 resides at the DCRBS Coordinator Computer 5, a DCRBS Peer Software on Peer Computer-I 501 resides at the Peer Computer-I 10, a DCRBS Peer Software on Peer Computer-II 502 resides at the Peer Computer-II 20, a DCRBS Peer Software on Peer Computer-III 503 resides at the Peer Computer-III 30, . . . , and a DCRBS Peer Software on Peer Computer-N 600 resides at the Peer Computer-N 100. As the shared computing resource of all the Peer computers are in fact shared by the same Coordinator computer, the DCRBS Coordinator Software 500 is distinctly different from all the Peer Software modules. On the other hand, except for minor differences in hardware and preference related settings at the time of installation, all the DCRBS Peer Software modules 501, 502, 503, . . . and 600 are essentially the same. Similar to the case of hardware, the associated Software routing path for data transmission amongst the software modules are illustrated by a set of dashed lines each with arrow heads at both ends. These are Software routing path between DCRBS Coordinator Computer and Peer Computer-I 601, Software routing path between DCRBS Coordinator Computer and Peer Computer-II 602, and Software routing path between Peer Computer-I and Peer Computer-II 603, etc. Therefore, with a single DCRBS Coordinator Software 500 and a multitude of DCRBS Peer Software modules like 501, 502, 503, etc. that communicate with one another through the software infrastructure of the Internet, certain fraction of computing resources of the individual computers can be bartered amongst them.

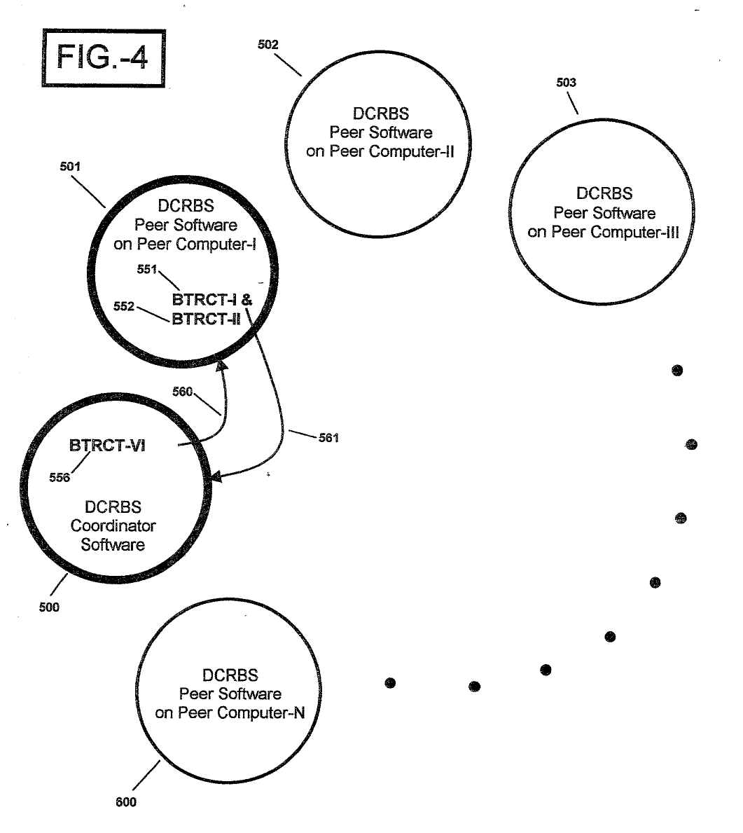

To be a highly comprehensive DCRBS system that can be efficiently implemented in software and will be capable of naturally handling the commercial bartering of a wide variety of computing and related resources within the participating Internet user community, the wide variety of items to be bartered need to be systematically classified and valuated. FIG. 3 details the major categories of classification of bartering items by the present Distributed Computer Resource Bartering System. Thus, the block of all major bartering items involving distributed computer resources 550 on the left side of FIG. 3 is classified into seven (7) major categories to the right.

Moving downwards from the top right hand corner of FIG. 3, the first category of the bartering items is the Bartering Resource Category-I, or BTRCT-I computing power 551. The computing power of a computer is typically rated in terms of Million Instructions processed Per Second, or MIPS. Alternatively, for signal processing and certain classes of scientific computation, the computing power is more properly rated in terms of Million Floating point Operations Per Second, or MFLOPS. For a given level of computing power in MIPS or MFLOPS, the cost of computing power of a computer is typically charged on a per-unit-time basis with a fixed hourly rate. Additionally, the higher the MIPS or MFLOPS, the higher the hourly rate will be. Therefore, the basic valuation of computing power 551 can be implemented with an algorithm within the DCRBS software using the parameters MIPS, MFLOPS and usage time.

The second category of the bartering items is the BTRCT-II computing memory 552 that includes, as shown, certain combination of high speed, solid state electronic memory such as SRAM, DRAM, etc. The basic grading of computing memory 552 typically consists of memory size and speed. For example, the memory size can be expressed in Megabytes, or MB, with more MB costing more. Additionally, the speed can be expressed in nanosecond, or ns, of Read and Write time, with smaller Read and Write time being faster thus costing more. Therefore, the basic valuation of computing memory 552 can be implemented with an algorithm within the DCRBS software using the parameters MB, ns of Read time, ns of Write time and usage time.

The third category of the bartering items is the BTRCT-III computing storage 553 such as a hard disk drive, a floppy disk drive, a CD-ROM or a tape drive. The valuation of these computing storage devices is qualitatively similar to that of the BTRCT-II computing memory 552 and thus can be implemented with an algorithm within the DCRBS software using the parameters of storage capacity, access time, Read time, Write time and usage time.

The fourth category of the bartering items is BTRCT-IV computer peripherals 554 including Image scanners, digital cameras and printers usually rated with their resolution, color depth and speed. The resolution is usually expressed in terms of pixels per inch for an image scanner or a printer, and number of pixels per image frame for a digital camera with higher resolution costing more. The color depth is usually expressed in terms of number of gray scale levels per primary color per pixel with higher color depth costing more. The speed is usually expressed in terms of number of standard-sized pages scanned per minute for an image scanner, number of standard-sized pages printed per minute for a printer, and number of image frames captured per minute for a digital camera with higher speed costing more. Therefore, the basic valuation of this category can be implemented with an algorithm within the DCRBS software using the parameters of resolution, color depth, speed and usage time.

The fifth category of the bartering items is the BTRCT-V computer files 555. The valuation of a computer file is highly complicated, dynamic and, in many cases, also highly subjective in nature and is not necessarily related to the size of the file itself For example, a small computer file for the decryption of another encrypted data file whose decrypted meaning is of critical importance to someone will be valued much higher than a huge multi-media file of video footage whose content has no copyright restriction. Therefore, the valuation of a computer file is best handled within the DCRBS software with an associated header file that describes the key attributes of the subject file in terms of its target user, objective, function, application environment, etc. and let the involved parties in the bartering process negotiate and decide its valuation.

The sixth category of the bartering items is the BTRCT-VI Internet Access 556. Specifically, it means the provision, to a computer user, of access to the Internet through a variety of communication devices and lines such as a voice modem, a cable modem, a DSL modem, a T1-line, a T3-line, or a fiber optical line, etc. The valuation of Internet Access usually comes from a combination of speed and Quality of Service, or QOS. The speed of Internet Access is expressed in terms of Kilobits/sec or Megabits/sec of data rate transferred to and from the user with higher speed costing more. The QOS of Internet Access has a specific set of statistically measurable parameters by the user and includes such items as percentage time of availability of the Internet Access, true information throughput, etc. with higher QOS costing more. Therefore, the basic valuation of the BTRCT-VI Internet Access 556 can be implemented with an algorithm within the DCRBS software using the parameters of speed, QOS and usage time.

The seventh category of the bartering items is the BTRCT-VII money 557, the simplest and most fundamental commerce enabler of all the categories. Here, we only remark that, to be a highly flexible bartering system, the implementation of money should take on a great variety of forms in addition to cash, such as credit, sweepstakes, commissions, etc.

With all the bartering items so categorized and valuated, the various software modules of the previously described DCRBS in FIG. 2 are now fully equipped to carry out the commercial exchange, or bartering, of computing resources naturally and efficiently among the corresponding Internet user community. A few examples of application of the DCRBS software are presented below to further clarify its preferred embodiment.

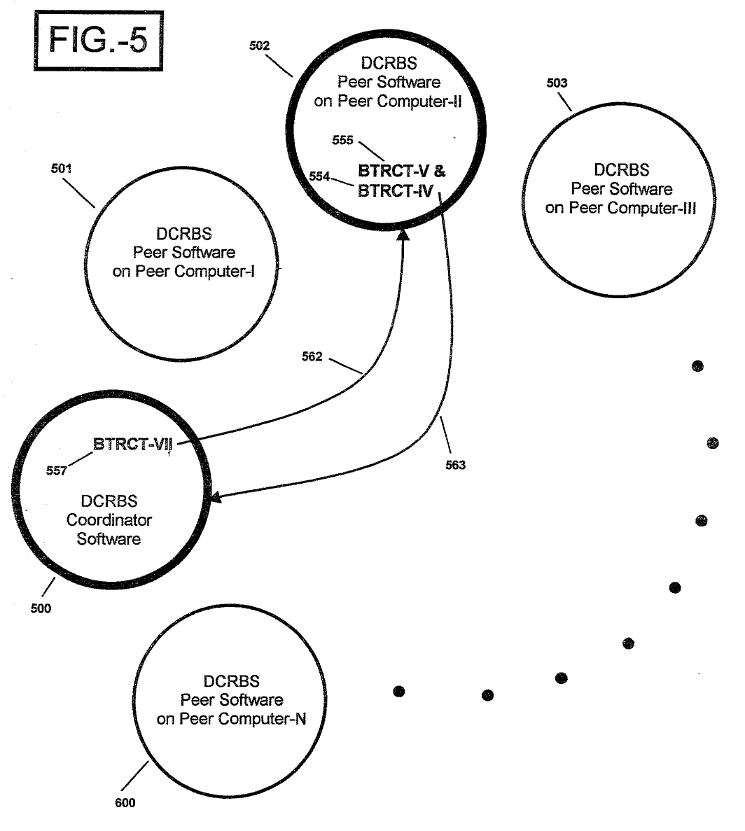

The first example of bartering within the Distributed Computer Resource Bartering System is illustrated in FIG. 4 where the subject bartering partners are the DCRBS Coordinator Software 500 and the DCRBS Peer Software on Peer Computer-I 501. To utilize the BTRCT-I computing power 551 and the BTRCT-II computing memory 552 from the DCRBS Peer Software on Peer Computer-I 501, the DCRBS Coordinator Software 500 would provide, valuation wise, an equitable amount of BTRCT-VI Internet Access 556 to the DCRBS Peer Software on Peer Computer-I 501. The corresponding software communication path for bartering are indicated by the bartering path from DCRBS Peer Software on Peer Computer-I to DCRBS Coordinator Software 561 and the bartering path from DCRBS Coordinator Software to DCRBS Peer Software on Peer Computer-I 560. Since the DCRBS Coordinator Software 500 can simultaneously carry out the same activity with other DCRBS Peer Software on other Peer Computers to harvest more computing power and computing memory, with no limit within the context of the Internet hardware and software infrastructure, the DCRBS Coordinator Software 500 can subsequently accomplish a massively distributed computing task.

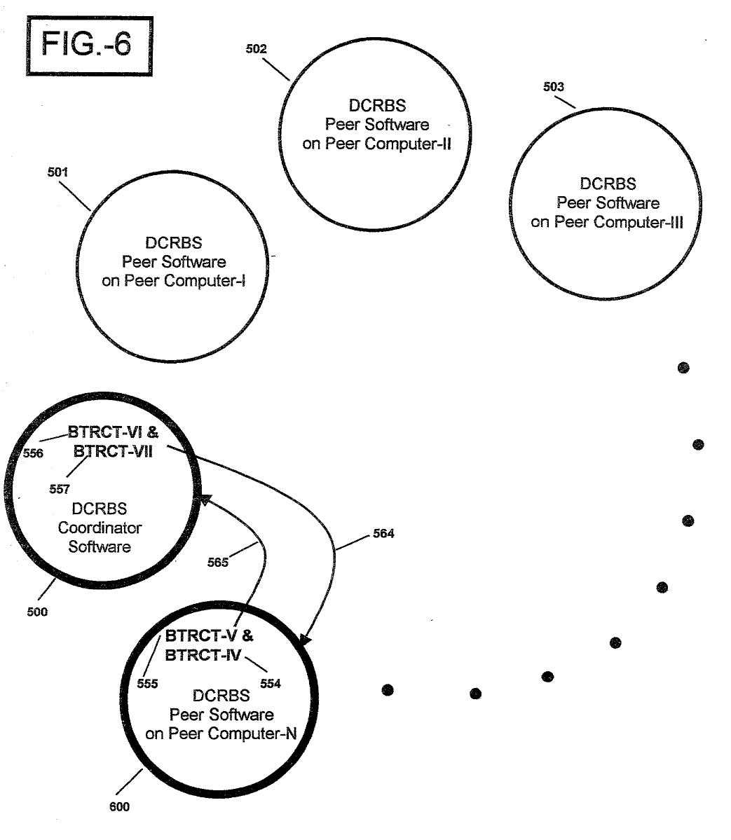

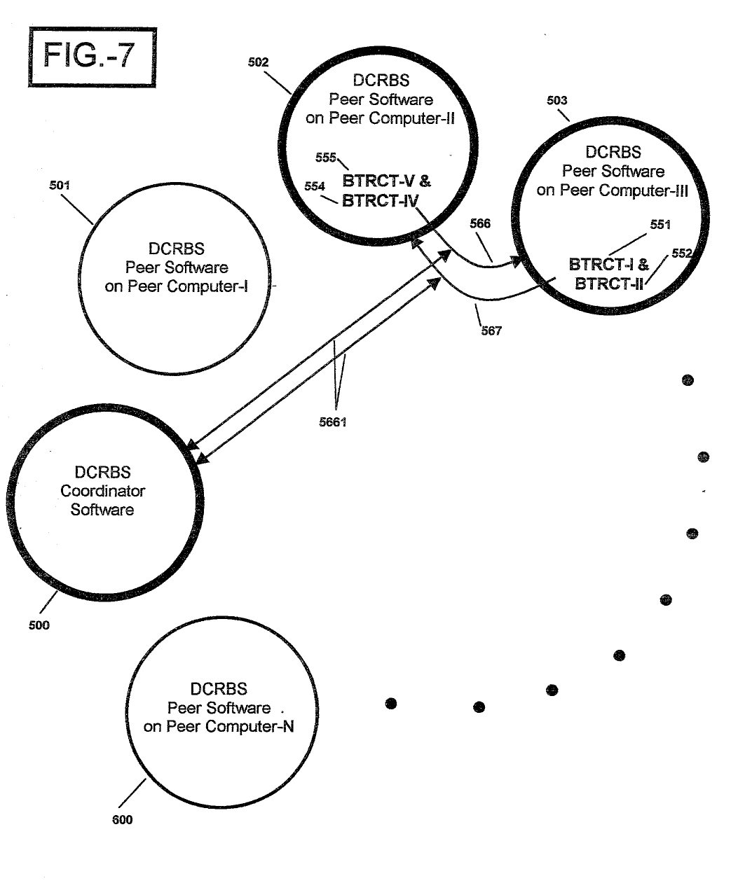

The second example of bartering within the DCRBS is illustrated in FIG. 5 where the subject bartering partners are the DCRBS Coordinator Software 500 and the DCRBS Peer Software on Peer Computer-II 502. To access the BTRCT-V computer files 555 and BTRCT-IV computer peripherals 554 from the DCRBS Peer Software on Peer Computer-II 502, the DCRBS Coordinator Software 500 would provide an equitable amount of BTRCT-VII money 557 to the DCRBS Peer Software on Peer Computer-II 502. The corresponding software communication path for bartering are indicated by the bartering path from DCRBS Peer Software on Peer Computer-II to DCRBS Coordinator Software 563 and the bartering path from DCRBS Coordinator Software to DCRBS Peer Software on Peer Computer-II 562. Since the DCRBS Coordinator Software 500 can simultaneously carry out the same activity with other DCRBS Peer Software on other Peer Computers to access more computer files and peripherals, with no limit within the context of the Internet hardware and software infrastructure, the DCRBS Coordinator Software 500 can subsequently implement a gigantic, massively distributed database.

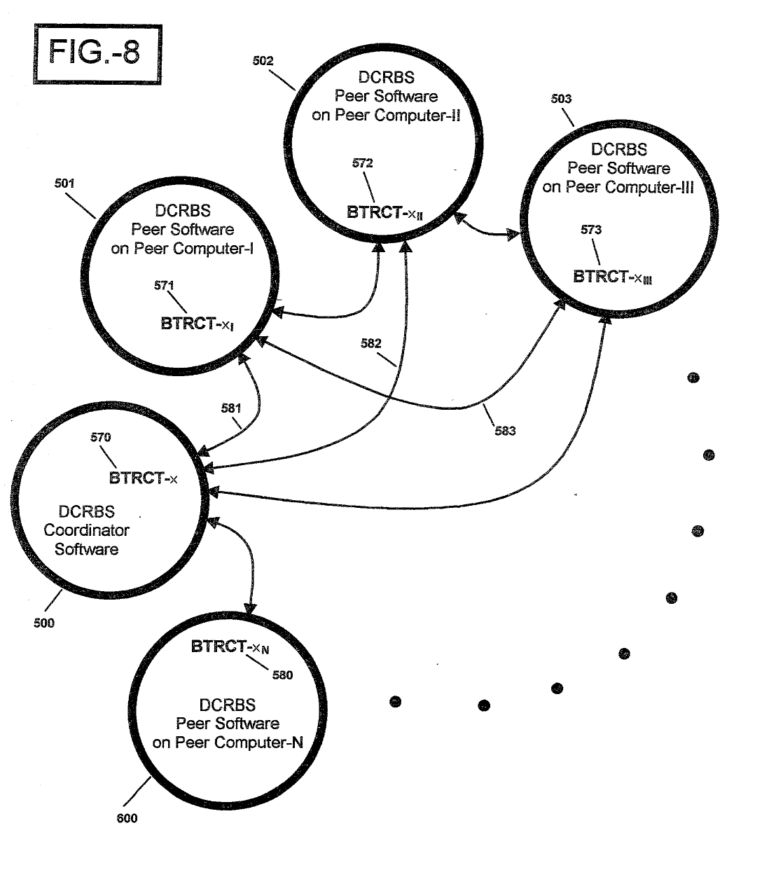

FIG. 6 illustrates a third example of bartering within the DCRBS where the subject bartering partners are the DCRBS Coordinator Software 500 and the DCRBS Peer Software on Peer Computer-N 600. To access the BTRCT-V computer files 555 and BTRCT-IV computer peripherals 554 from the DCRBS Peer Software on Peer Computer-N 600, the DCRBS Coordinator Software 500 would provide a BTRCT-VI Internet Access 556 plus an amount of BTRCT-VII money 557 to the DCRBS Peer Software on Peer Computer-N 600. The corresponding software communication path for bartering are indicated by the bartering path from DCRBS Peer Software on Peer Computer-N to DCRBS Coordinator Software 565 and the bartering path from DCRBS Coordinator Software to DCRBS Peer Software on Peer Computer-N 564. Since the DCRBS Coordinator Software 500 can simultaneously carry out the same activity with other DCRBS Peer Software on other Peer Computers to access more computer files and peripherals, with no limit within the context of the Internet hardware and software infrastructure, the DCRBS Coordinator Software 500 can subsequently quickly perform a huge printing service if the accessed massively distributed peripherals are all laser printers.

FIG. 7 illustrates a fourth example of bartering within the DCRBS where the subject bartering partners are the DCRBS Peer Software on Peer Computer-II 502 and the DCRBS Peer Software on Peer Computer-III 503 with the bartering activity coordinated by the DCRBS Coordinator Software 500. To access the BTRCT-I computing power 551 and the BTRCT-II computing memory 552 from the DCRBS Peer Software on Peer Computer-III 503, the DCRBS Peer Software on Peer Computer-II 502 would provide an equitable amount of BTRCT-V computer files 555 and BTRCT-IV computer peripherals 554 to the DCRBS Peer Software on Peer Computer-III 503. This represents an example of a Peer-to-Peer Electronic Commerce coordinated by the DCRBS coordinator. The corresponding software communication path for bartering are indicated by the bartering path from DCRBS Peer Software on Peer Computer-III to DCRBS Peer Software on Peer Computer-II 567 and the bartering path from DCRBS Peer Software on Peer Computer-II to DCRBS Peer Software on Peer Computer-III 566. The accompanying software communication path for coordination are indicated by the coordinating path for bartering between DCRBS Peer Software on Peer Computer-II and DCRBS Peer Software on Peer Computer-III 5661. As a coordinator of the subject Peer-to-Peer Electronic Commerce, the DCRBS Coordinator Software 500 can negotiate, beforehand, certain amount of commission from either or both of the DCRBS Peer Software on Peer Computer-II 502 and DCRBS Peer Software on Peer Computer-III 503. Of course, to be flexible, other Peer-to-Peer bartering processes can and should be allowed to take place independent of the DCRBS Coordinator Software 500.

FIG. 8 illustrates a generalized view of bartering within the DCRBS wherein a multitude of bartering activities amongst the Coordinator software module and numerous Peer software modules take place simultaneously. Thus, in general, the DCRBS Coordinator Software 500 uses a Generalized BTRCT-x used by DCRBS Coordinator Software 570. The DCRBS Peer Software on Peer Computer-I 501 uses a Generalized BTRCT-x_{I} used by DCRBS Peer Software on Peer Computer-I 571. The DCRBS Peer Software on Peer Computer-II 502 uses a Generalized BTRCT-x_{II} used by DCRBS Peer Software on Peer Computer-II 572. The DCRBS Peer Software on Peer Computer-III 503 uses a Generalized BTRCT-x_{III} used by DCRBS Peer Software on Peer Computer-Ill 573. The DCRBS Peer Software on Peer Computer-N 600 uses a Generalized BTRCT-x_{N} used by DCRBS Peer Software on Peer Computer-N 580. Some of the simultaneous bartering paths illustrated here are the bartering path between DCRBS Coordinator Software and DCRBS Peer Software on Peer Computer-I 581, the bartering path between DCRBS Coordinator Software and DCRBS Peer Software on Peer Computer-II 582 and the bartering path between DCRBS Peer Software on Peer Computer-I and DCRBS Peer Software on Peer Computer-III 583. Certainly, with such a massively parallel yet coordinated network, through the DCRBS Coordinator Software 500, of DCRBS Peer Software modules operating at the corresponding Peer Computers, the task of representative Peer-to-Peer Web site security testing and Web performance testing can now be accomplished within a reasonable amount of time. Furthermore, the described software architecture of the present invention is naturally scalable in that, as the size of the corresponding Internet user community grows, no major change of the architecture of the associated operating software modules needs to take place to maintain its functionality and performance.

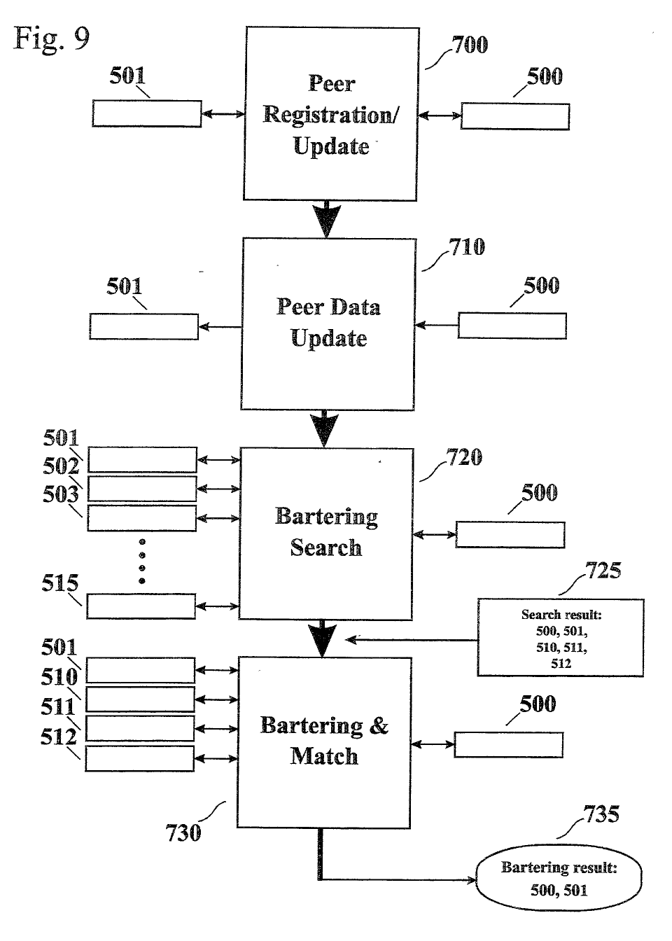

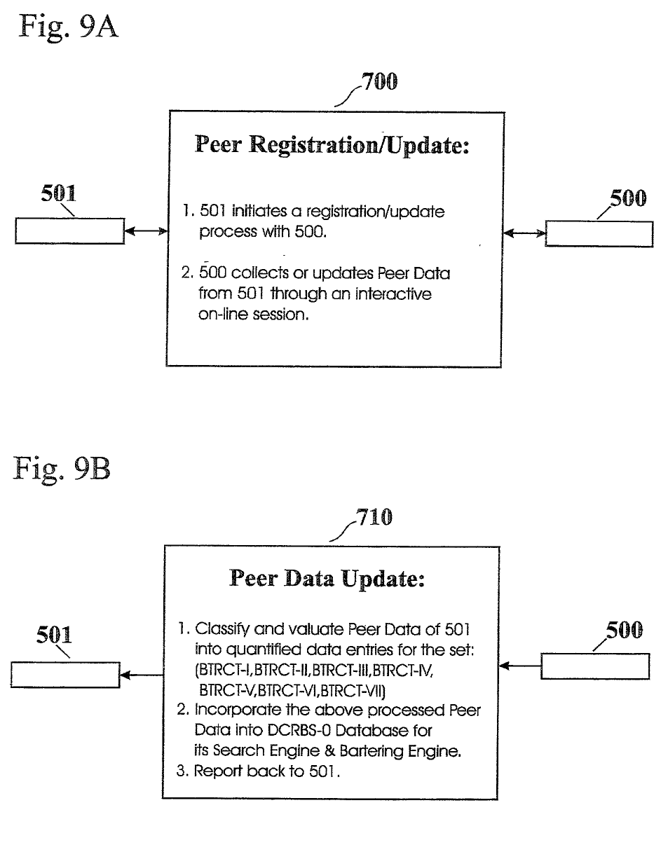

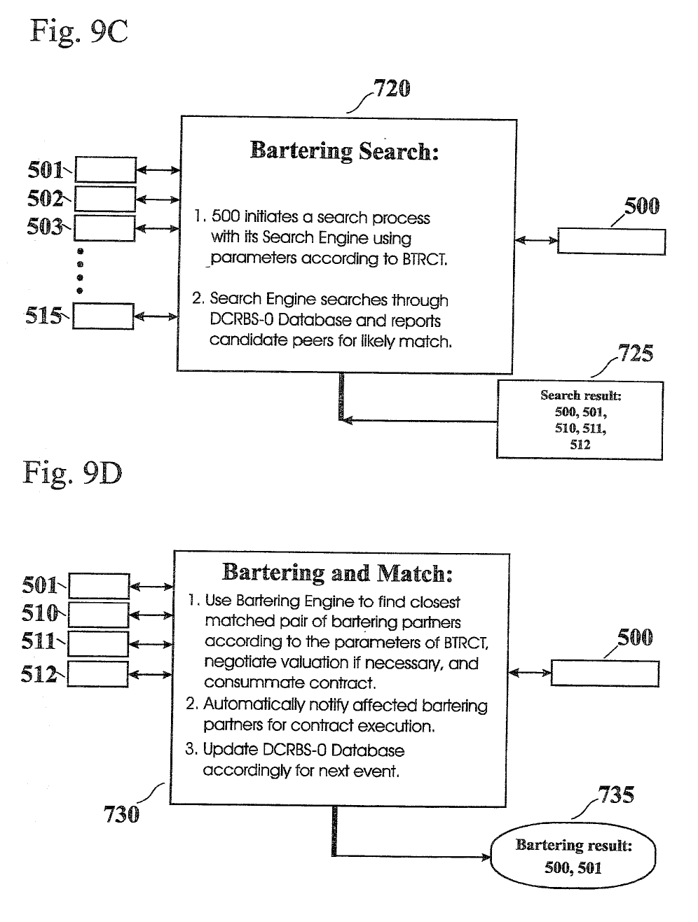

To further elucidate the method of DCRBS of the current invention, FIG. 9 details the process flow of the first example of bartering from FIG. 4. To become one of the members of the DCRBS, DCRBS Peer Software on Peer Computer-I 501 initiates a first procedure called Peer Registration/Update 700 whereby DCRBS Peer Software on Peer Computer-I 501 interacts with DCRBS Coordinator Software 500 to allow DCRBS Coordinator Software 500 to collect or update data from DCRBS Peer Software on Peer Computer-I 501 relevant to the DCRBS operation. The underlying means of communication is Internet Hardware Infrastructure 200 already explained before. As a result, DCRBS Coordinator Software 500 can now process the just collected data for the purpose of future DCRBS activity and reports the result to DCRBS Peer Software on Peer Computer-I 501, through a second procedure called Peer Data Update 710. As the described procedures of Peer Registration/Update 700 and Peer Data Update 710 can certainly happen between DCRBS Peer Software on any other Peer Computers and DCRBS Coordinator Software 500, it should be clear by now that a DCRBS Coordinator Software 500-resident database of all the participating Peer Computers can be built up this way for DCRBS operation.

To look for usable BTRCT-I computing power 551 and BTRCT-II computing memory 552 from the participating DCRBS community, DCRBS Coordinator Software 500 initiates a third procedure called Bartering Search 720 amongst participating DCRBS community involving, potentially, all the DCRBS Peer Software on Peer Computer-I 501, DCRBS Peer Software on Peer Computer-II 502, DCRBS Peer Software on Peer Computer-III 503, . . . , and DCRBS Peer Software on Peer Computer-N 515. The Search result 725 whose detail will be presently described, are the candidates DCRBS Coordinator Software 500, DCRBS Peer Software on Peer Computer-I 501, DCRBS Peer Software on Peer Computer-K 510, DCRBS Peer Software on Peer Computer-L 511 and DCRBS Peer Software on Peer Computer-M 512. This is followed by a fourth procedure called Bartering & Match 730 involving the same candidates and the Bartering & Match 730 produces Bartering result 735 involving DCRBS Coordinator Software 500 and DCRBS Peer Software on Peer Computer-I 501. In this example, as depicted in FIG. 4, an equitable amount of BTRCT-VI Internet Access 556 of DCRBS Coordinator Software 500 is bartered for BTRCT-I computing power 551 and BTRCT-II computing memory 552 from DCRBS Peer Software on Peer Computer-I 501.

As a final level of detailed explanation, the details of the individual blocks of FIG. 9 are presented respectively in FIG. 9A, FIG. 9B, FIG. 9C and FIG. 9D. In FIG. 9A, the first procedure Peer Registration/Update 700 further consists of two steps. In the first step, DCRBS Peer Software on Peer Computer-I 501 initiates a registration/update process with DCRBS Coordinator Software 500. This is an interactive, on-line session working through the Internet Hardware Infrastructure 200 whereby DCRBS Coordinator Software 500 would collect or update Peer Data from DCRBS Peer Software on Peer Computer-I 501. Some example of the Peer Data collected are peer identity, peer demographic and peer BTRCT information relevant to the DCRBS operation.

In the second procedure of Peer Data Update 710 shown in FIG. 9B, DCRBS Coordinator Software 500 would classify and valuate the just collected Peer Data of DCRBS Peer Software on Peer Computer-I 501 into quantified data entries for the set (BTRCT-I, BTRCT-II, BTRCT-III, BTRCT-IV, BTRCT-V, BTRCT-VI, BTRCT-VII) in a manner already explained in FIG. 3 before. Next, DCRBS Coordinator Software 500 would incorporate the just processed Peer Data into a DCRBS-0 Database to be used by two functional software modules respectively called Search Engine and Bartering Engine whose function will also be presently explained. Finally, the processed result are also reported back to DCRBS Peer Software on Peer Computer-I 501 to close the loop.

In the first step of Bartering Search 720 as shown in FIG. 9C, DCRBS Coordinator Software 500 would initiate a search process with its search engine using parameters as already described in BTRCT. Thus, in the second step of Bartering Search 720, the search engine would search through the pre-built DCRBS-0 Database and report candidate peers for likely match according to the parameters of, in this case, BTRCT-I computing power 551 and BTRCT-II computing memory 552. In this example, the illustrated Search result 725 are DCRBS Coordinator Software 500, DCRBS Peer Software on Peer Computer-I 501, DCRBS Peer Software on Peer Computer-K 510, DCRBS Peer Software on Peer Computer-L 511 and DCRBS Peer Software on Peer Computer-M 512.

The details of Bartering & Match 730 are illustrated in FIG. 9D wherein the first step consists of DCRBS Coordinator Software 500 using the bartering engine to find closest matched pair of bartering partners from the set of bartering candidates (DCRBS Coordinator Software 500, DCRBS Peer Software on Peer Computer-I 501, DCRBS Peer Software on Peer Computer-K 510, DCRBS Peer Software on Peer Computer-L 511 and DCRBS Peer Software on Peer Computer-M 512) also according to the parameters of BTRCT. Automatic negotiation algorithm or negotiation algorithm with human intervention are implemented in the bartering engine for the relevant valuation parameters to reach a bartering contract. Upon consummation of the contract, as illustrated by Bartering result 735 consisting of DCRBS Coordinator Software 500 and DCRBS Peer Software on Peer Computer-I 501, DCRBS Coordinator Software 500 would automatically notify the affected bartering partners for contract execution in the second step. In the last step of Bartering & Match 730, DCRBS Coordinator Software 500 would automatically update the DCRBS-0 Database accordingly for future bartering activities.

As seen, a set of preferred embodiments of a Distributed Computer Resource Bartering System of the current invention is presented above. However, for those skilled in this field, the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

I claim:

1. A Distributed Computer Resource Bartering System, or DCRBS, comprising:
a plurality of independent computing devices connected to one another through a network wherein each of the computing devices is provided with a variety of computing resources;
a coordination means installed on one of the computing devices to designate functionally a coordination computing device to coordinate the bartering of the variety of computing resources amongst all the computing devices;
a bartering means installed on each of all the computing devices to designate functionally a plurality of computing devices to barter the variety of computing resources amongst all the computing devices; and
whereby a fraction of the computing resources of the individual computing device is bartered amongst them by the bartering means through the coordination of the coordination means such that the coordination computing device and the plurality of individual peer computing devices simultaneously communicate and functionally operate with one another through the network to perform an application.

2. The Distributed Computer Resource Bartering System according to claim 1 wherein the network is a Local Area Network, a Wide Area Network or the Internet.

3. The Distributed Computer Resource Bartering System according to claim 1 wherein said variety of computing resources are individually valued and systematically classified into a number of major bartering categories to effect a commerce driven bartering mechanism.

4. The Distributed Computer Resource Bartering System according to claim 3 wherein the major bartering categories are selected from the group consisting of computing power, computing memory, computing storage, computer peripherals, computer files, network access, and money.

5. The Distributed Computer Resource Bartering System according to claim 4 wherein the computing power is valuated using parameters from the group comprising MIPS, MFLOPS and usage time.

6. The Distributed Computer Resource Bartering System according to claim 4 wherein the computing memory is valuated using parameters from the group comprising MB, ns of Read time, ns of Write time and usage time.

7. The Distributed Computer Resource Bartering System according to claim 4 wherein the computing storage is valuated using parameters from the group comprising MB, ms of Read time, ms of Write time and usage time.

8. The Distributed Computer Resource Bartering System according to claim 4 wherein the computer peripherals is valuated using parameters from the group comprising resolution, color depth, speed and usage time.

9. The Distributed Computer Resource Bartering System according to claim 4 wherein the computer files is valuated using parameters from the group comprising a series of respectively associated descriptive header files.

10. The Distributed Computer Resource Bartering System according to claim 4 wherein the network access is valuated using parameters from the group comprising speed, QOS and usage time.

11. The Distributed Computer Resource Bartering System according to claim 4 wherein the money further comprises a subset of bartering items selected from the group consisting of cash, credit, sweepstakes and commissions.

12. The Distributed Computer Resource Bartering System according to claim 1 wherein the coordination computing device and one or more of the individual peer computing devices form one or more DCRBS communities that may either independently function or communicate and coordinate with one another simultaneously through the network for bartering activity.

13. The Distributed Computer Resource Bartering System according to claim 1 wherein the application includes, but not limited to, massively distributed computing, Peer-to-Peer Electronic Commerce, Peer-to-Peer file swapping, Web site security testing, Web performance testing, PEER-TO-PEER Streamline Media Broadcasting, Web Indexing Spider, Peer Software Router, PEER-TO-PEER Game Coordinator, Wireless PEER-TO-PEER Digital Content Swapping Platform, advanced information search engines and self-balanced data routing networks.

14. A Distributed Computer Resource Bartering System, or DCRBS, comprising:
a plurality of independent computing devices connected to one another through a network wherein each of the computing devices is provided with a variety of computing resources;
a bartering means installed on each of the computing devices to designate functionally a plurality of individual peer computing devices to barter the variety of computing resources amongst the individual peer computing devices; and
whereby a fraction of the computing resources of the individual peer computing device is bartered amongst them by the bartering means such that the plurality of individual peer computing devices simultaneously communicate and functionally operate with one another through the network to perform an application.

15. A method of performing a Distributed Computer Resource Bartering, or DCRB, comprising the steps of:
connecting a plurality of independent computing devices one another through a network wherein each of the computing devices is provided with a variety of computing resources;
installing a coordination means on one of the computing devices to designate functionally a coordination computing device to coordinate the bartering of the variety of computing resources amongst all the computing devices;
installing a bartering means on each of all the computing devices to designate functionally a plurality of computing devices to barter the variety of computing resources amongst all the computing devices; and
bartering a fraction of the computing resources of the individual computing devices amongst them by the bartering means through the coordination of the coordination means such that the coordination computing device and the plurality of individual peer computing devices simultaneously communicate and functionally operate with one another through the network to perform a desirable application.

16. The method of performing a Distributed Computer Resource Bartering according to claim 15 wherein the network is a Local Area Network, a Wide Area Network or the Internet.

17. The method of performing a Distributed Computer Resource Bartering according to claim 16 wherein said variety of computing resources are individually valued and systematically classified into a number of major bartering categories to effect a commerce driven bartering mechanism.

18. The method of performing a Distributed Computer Resource Bartering according to claim 15 wherein the major bartering categories are selected from the group consisting of computing power, computing memory, computing storage, computer peripherals, computer files, network access, and money.

19. The method of performing a Distributed Computer Resource Bartering according to claim 18 wherein the computing power is valuated using parameters from the group comprising MIPS, MFLOPS and usage time.

20. The method of performing a Distributed Computer Resource Bartering according to claim 18 wherein the computing memory is valuated using parameters from the group comprising MB, ms of Read time, ms of Write time and usage time.

21. The method of performing a Distributed Computer Resource Bartering according to claim 18 wherein the computing storage is valuated using parameters from the group comprising MB, ms of Read time, ms of Write time and usage time.

22. The method of performing a Distributed Computer Resource Bartering according to claim 18 wherein the computer peripherals is valuated using parameters from the group comprising resolution, color depth, speed and usage time.

23. The method of performing a Distributed Computer Resource Bartering according to claim 18 wherein the computer files is valuated using parameters from the group comprising a series of respectively associated descriptive header files.

24. The method of performing a Distributed Computer Resource Bartering according to claim 18 wherein the network access is valuated using parameters from the group comprising speed, QOS and usage time.

25. The method of performing a Distributed Computer Resource Bartering according to claim 18 wherein the money further comprises a subset of bartering items selected from the group consisting of cash, credit, sweepstakes and commissions.

26. The method of performing a Distributed Computer Resource Bartering according to claim 15 further comprises the step of forming one or more DCRBS communities each comprising the coordination computing device and one or more of the individual peer computing devices that may either independently function or communicate and coordinate with one another simultaneously through the network for bartering activity.

27. The method of performing a Distributed Computer Resource Bartering according to claim 15 wherein the application includes, but not limited to, massively distributed computing, Peer-to-Peer Electronic Commerce, Peer-to-Peer file swapping, Web site security testing, Web performance testing, PEER-TO-PEER Streamline Media Broadcasting, Web Indexing Spider, Peer Software Router, PEER-TO-PEER Game Coordinator, Wireless PEER-TO-PEER Digital Content Swapping Platform, advanced information search engines and self-balanced data routing networks.
